(19) United States
(12) Patent Application Publication
(10) Pub. No.: US 2015/0027322 A1
(43) Pub. Date: Jan. 29, 2015

(54) Cooking Apparatus

(71) Applicant: Parag Konde, Spring, TX (US)

(72) Inventor: Parag Konde, Spring, TX (US)

(21) Appl. No.: 14/444,992

(22) Filed: Jul. 28, 2014

Related U.S. Application Data
(60) Provisional application No. 61/859,324, filed on Jul. 29, 2013.

(51) Int. Cl. A47J 37/04

(52) U.S. Cl. CPC A47J 37/041
USPC 99/421 H

(57) ABSTRACT

The invention provides a shish kebab type skewer and cooking rack system that supports at least two skewers in a plurality of positions, the novel skewers having an indexing means to fix the position of rotation of the skewer about the rotational axis in at least two positions. The skewers are provided with indexing members that overlap to permit moving all skewers with a single adjustment. The rack system can be used with a conventional backyard grill or indoors in a oven or stove top environment.

### RELATED APPLICATION

The present application claims priority of U.S. Provisional Patent Application Ser. No. 61/859,324, entitled “Rotatable skewers cooking apparatus to uniformly cook food on all sides” filed Jul. 29, 2013.

### TECHNICAL FIELD

The present invention generally relates to a shish kebab cooking device and more particularly to a skewer and rack system for cooking a plurality of food items with an improvement for rotating the plurality of skewers during cooking either simultaneously to assure uniform cooking or incrementally to provide more uniform cooking within a skewer, and in either embodiment increase the safe handling of the skewer.

### BACKGROUND OF THE INVENTION

Home and restaurant preparation of food over a grill or in an enclosed oven type cooker is widely practiced. Shish kebab type dishes are particularly popular, and many variations are well known. Rack systems for shish kebab preparation are known. A typical system is disclosed in Netter, U.S. Pat. No. 6,474,224. Netter's system provides support of a group of skewers with the added feature of a “keeper rod” that holds the skewers in place. However in the prior art there are no simple systems for rotating a group of skewers at or near the same time or for fixing the skewers in incremental rotational positions to assure uniform cooking of food on multiple skewers. The present invention provides a solution to this lack in the prior art.

### SUMMARY OF THE INVENTION

The invention provides a novel food positioning and supporting skewer for use in a cooking rack system that supports at least one skewer in a plurality of positions, the skewer having an elongated member that includes a proximate end, a distal end, a rotational axis and a tip positioned at the distal end and a support area between the distal end and the proximal end for supporting a plurality of food items; the improvement that comprises an indexing means to fix the position of rotation of the elongated member about the rotational axis in at least two positions. The indexing means may comprise a second elongated member disposed at an angle to the rotational axis of the first elongated member that fixes the rotational position of the skewer in a first position and a second position. Alternatively the indexing means comprises a second elongated member disposed at an angle to the rotational axis of the first elongated member that fixes the rotational position of the skewer in a first position and a second position by contact with a portion of the rack system. The indexing means of said skewer is preferably of sufficient length to overlap adjacent second skewer of the same design as said first skewer when the two skewers are placed in a rack system having means for supporting at least two skewers in parallel to one another and said rack system support means having a fixed spacing of said first and second skewers and the overlap of said elongated second members interacting to rotate the adjacent second skewer when said first skewer is rotated. The skewer indexing means may provide a plurality of indexed stop positions to allow the skewer to be fixed in at least two or more rotational positions relative to engaging means of the cooking rack system. Engaging means may be protrusions from the support rack, such as studs or a continuous rail or step across the front, a notch or step in the side supports or any other means to fix the position of a skewer. A preferred embodiment further comprises a stop means that holds the skewer in a fixed relationship to the rack system to prevent the skewer from falling from the rack. The stop means may be a shoulder on the skewer or the lever means or other stops integral to the skewer that prevent it from sliding out of engagement with the rack means.

The invention may also be viewed as a cooking rack system for used in combination with at least two skewers having an indexing means and comprising a first support means disposed in relationship to a second support means, the distance separating the first support means from the second support means being less than the distance between the skewer tip and the proximate end of said skewers, and the spacing being sufficient to provide exposure of food placed on the skewer to a heat source near the rack system, and each of said support means having positioning means for holding the at least two skewers in at least one fixed position. The rack system preferably provides first and second support are spaced apart a distance less than the length of the skewers to be supported, but far enough apart to provide space for food items along more than half the length of the skewers. In a preferred embodiment the first and second support members each have apertures for receiving the skewers and means to engage an indexing means of the skewer to stop rotational movement of the skewer. Apertures may include holes, slots, or other shaped openings that allow positioning of the skewers in a spaced relationship along the support members. A preferred rack system provides positioning means, such as apertures, holes, slots, grooves and the like, for holding the at least two skewers in at least one fixed spaced relationship and further comprises a support means having an aperture receivingly engaging the distal end of each skewer and said positioning means also comprising a second support means further comprising a slot that receivingly engages a portion of the skewer with its distal end engaged with the support means in a spaced apart relationship to said distal end, such that when the skewer is receivingly engaged with the second support means the position of the food supporting portion of the skewer is fixed relative to adjacent skewers. In a preferred system a stop means is positioned on the skewer and the skewer stop means engages the slotted support means to prevent the skewer from slipping out of engagement with the distal end support means unless the skewer is moved out of engagement with the second support means. In a preferred rack support system the first and second support members are portions of a closed geometric figure and the support member receivingly engaging the distal end of the skewer is further provided with means for preventing accidental contact with the tip of the skewer. The support system may also provide a member of the skewer that prevents the skewer from being withdrawn from the aperture in the member having an enclosed aperture unless the skewer is moved out of engagement with the second support member. A preferred rack system provides interaction of the skewer with a first support member prevents motion of the skewer toward the distal end and a second portion of the skewer spaced apart from the first support member portion of the skewer prevents movement of the skewer away from the first support member. In a preferred rack system the indexing means of each skewer is disposed at an angle large enough to permit the indexing means to overlap an adjacent skewer such that rotating the first skewer toward the second skewer will rotate each adjacent skewer to a second position. A stop means may also be positioned to engage an indexing means of a skewer to stop rotation of the skewer about the axis of rotation of the skewer.

Another preferred embodiment provides each skewer with an indexing means that can engage an adjacent skewer when the skewers are placed in engagement with the rack system and the rack system also has a removable stop means to selectively engage an indexing means of a skewer to provide an intermediate stop position when a skewer is rotated such that the degree of rotation of the skewer is less than 180 degrees of rotation from its starting position, and removal of removable stop allows further rotation of the skewer in the same direction of rotation to a second rotational position. The indexing means that engages the adjacent skewer may be configured so that it does not engage the removable stop means of the rack system, the rotation of the skewers being stopped by engagement of an indexing means of a second skewer with the removable stop.

### BRIEF DESCRIPTION OF THE DRAWINGS

FIG. 1 shows an isometric view of multiple skewers and supporting rack system of the invention.

FIG. 2 shows a skewer with larger perpendicular lever indexing means, stop and handle.

FIG. 3 shows a skewer with larger perpendicular lever indexing means.

FIG. 4 shows a skewer as illustrated in FIG. 1 with multiple rotational position index means and a preferred cross section.

FIG. 5 shows the placement of food items in the food support area of the skewer and positioning of food items in the support means.

FIGS. 6A-G show rotational positions of adjacent levered skewers during rotation around the axis of the skewer.

FIG. 7 shows an isometric view of a basic support means.

FIG. 8 shows an isometric view of a support means with indexing stops.

FIG. 9 an isometric view of a support rack with skewers from the side supporting the skewer handles with lever indexing means.

FIG. 10 shows an isometric view of the apparatus of FIG. 9 from the side supporting the skewer tips

FIG. 11 shows an isometric view of an alternative rack system wherein the side panels serve as stops from the front side.

FIG. 12 shows an isometric view of an alternative rack system wherein the side panels serve as stops from the rear side.

### DETAILED DESCRIPTION OF THE INVENTION

The invention provides a cooking apparatus such as that illustrated in

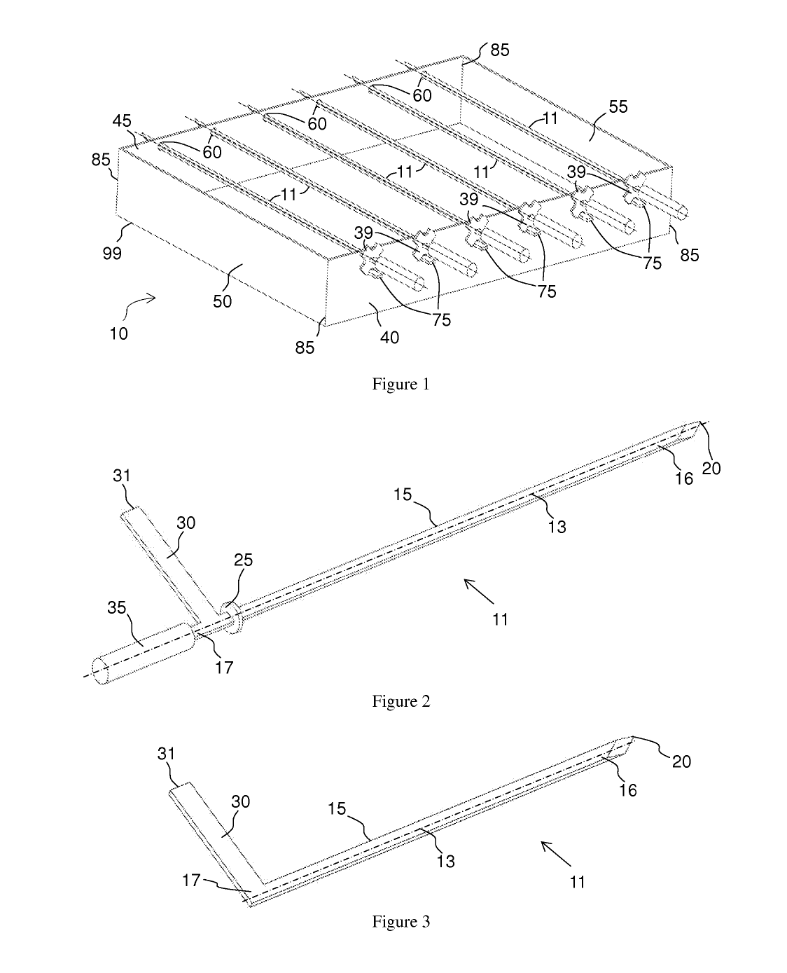

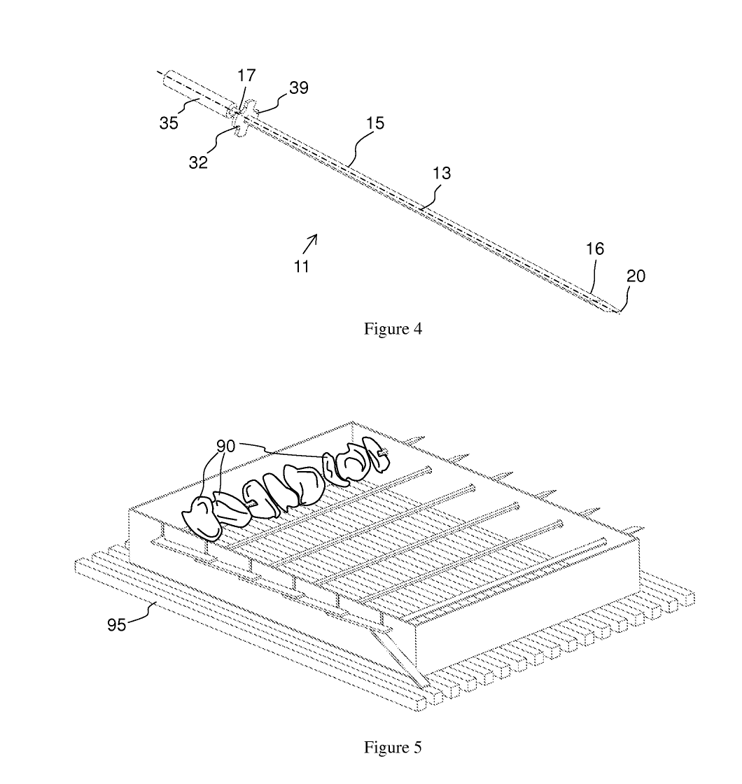

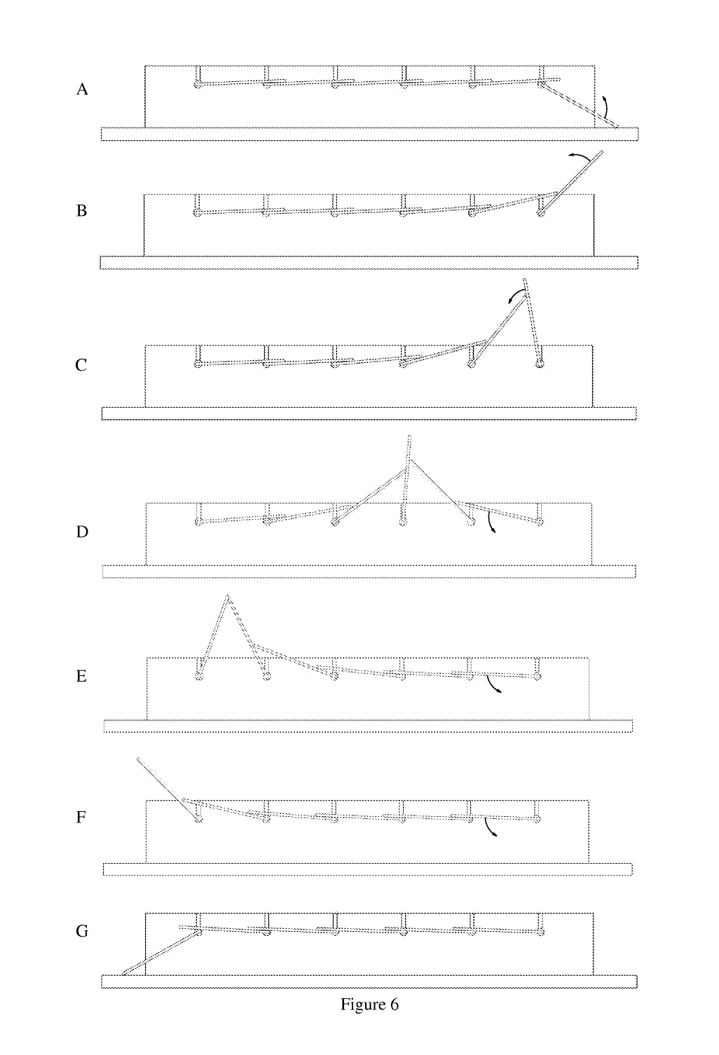

FIG. 1, suitable for preparation of shish kebob and similar dishes. The invention provides novel skewers having an indexing means comprising at least one lever at an angle to the support area for food or multiple short levers as in FIG. 1. A preferred skewer design shown in FIGS. 2 and 3 has a second elongated member 30 or other indexing means that can be arranged in such a way that the second elongated member 30 or other indexing means contacts an adjacent skewer. The second elongated member or other indexing means permits rotating all the skewers by rotating a single skewer as is further illustrated in FIGS. 6 A-G. For transmission of rotary motion the right most skewer lever rests on the right most lever stop and all the skewers are placed with the lever toward the right, and resting on the skewer lever of the skewer to the right, as shown in Position A of FIG. 6. The multiple lever indexing means skewers of FIG. 1 are shown separately in FIG. 4. The multiple levers may also be extended to interact with adjacent skewers if desired. When the user desires to turn the cooking food, the levers interact to turn in unison as shown in FIG. 6 and in sequence as rotation progresses in 6 A-G. As illustrated in FIG. 6, a user can rotate the right most skewer lever by applying force in the direction shown in Position A causing all skewers simultaneously to rotate in the direction of the applied force. If the motion goes to a full half turn then all skewers end at a position such as the position shown in FIG. 6G.

An embodiment of skewer rack system 10 is illustrated in FIG. 1. The skewer rack system 10 has a substantially rectangular rack 99 made of heat resistant coated or non-coated material such as metal, ceramic, polymer, or composite with melting point and charring point above the grilling temperature. Preferably the skewers and support are food grade metal suitable for cooking such as 304 stainless steel. The rectangular rack 99 is oriented in a horizontal plane on a cooking surface, such as a grate of an outdoor barbecue grill or within a different cooking environment, such as in an indoor convection oven.

In one embodiment the rectangular rack 99 is made of four panels as in FIG. 1. A pair of parallel panels is denoted as front panel 40 and rear panel 45. Perpendicular to front panel 40 and rear panel 45, the rectangular rack 99 is provided with a pair of side panels, namely, left side panel 50 and right side panel 55. The front panel 40, rear panel 45, left side panel 50 and right side panel 55 could be constructed from single sheet of plate bent at four corners 85. In other embodiment the front panel 40, rear panel 45, right side panel 50 and left side panel 55 may be made out of separate sheets that can be mechanically joined with for example using nuts and bolts, pivoted hinges, rivet and/or welding at the corners 85. In another embodiment the panels may also be glued or magnetically assembled with each other at the corners 85. In another embodiment the front panel 40, rear panel 45, right side panel 50 and left side panel 55 may be made out of metal wire fabricated appropriately to form support members for skewers. The embodiment is provided with shish kebab skewers 11 shown in FIG. 1 and FIG. 2. Skewer 11 as seen in FIGS. 2 and 3 includes an elongated member 15, a handle 35 in FIG. 2, a shoulder 25, and a perpendicular member 30.

In the non-limiting embodiments shown in FIGS. 2 and 3, elongated member 15 is made or manufactured from a rigid material (e.g., wood, ceramic, thermoplastic, metal, alloy or composite) suitable for use in cooking to contact food at high temperatures. Member 15 may have any cross sectional shape, however a shape that limits rotation of food items relative to the skewer is preferred. Elongated member 15 includes a distal end 16 and a proximate end 17. Distal end 16 includes a pointed and/or thinned tip portion 20 which assists a user of skewer 11 in impaling desired food items to be placed onto elongated member 15. Towards the proximate end 17, elongated member 15 is optionally provided with a shoulder 25 as in FIG. 2. Plane of shoulder 25 is substantially perpendicular to the long axis of elongated member 15. The long axis 13 of elongated member 15 is also the axis of rotation for adjusting the position of the food being cooked. At proximate end 17, elongated member 15 is attached, coupled and/or connected to one or more levers 30. Lever 30 is attached in a substantially perpendicular plane to the long axis of the elongated member 15. In this non-limiting embodiment, cross section of lever 30 may be any shape, preferably a flat rectangular polygonal, oval or elliptical. In another embodiment, proximate end 17 of the elongated member 15 may be attached, coupled and/or connected to a handle 35. The cross section of handle 35 may be any shape such as rectangular, polygonal, polygon with rounded corners, elliptical or circular. In another embodiment, lever 30 may have lever end 31 equipped with a roller, a ball, or nothing at all as in FIGS. 2 and 3. An additional alternate embodiment having a multilever indexing means 39 is shown in FIG. 4 where the reference numerals have the same meaning as set out above. A plurality of skewer rests 32 are formed by joining multilever indexing means 39 as shown in FIG. 4. In FIG. 5 a plurality of food items 90 are illustrated in the food support area of a skewer of the type shown in FIG. 3 with a support rack placed on grill 95, which also serves as a stop for the right most skewer. The interaction of the overlapping skewer levers is further illustrated in FIGS. 6A-G as discussed below.

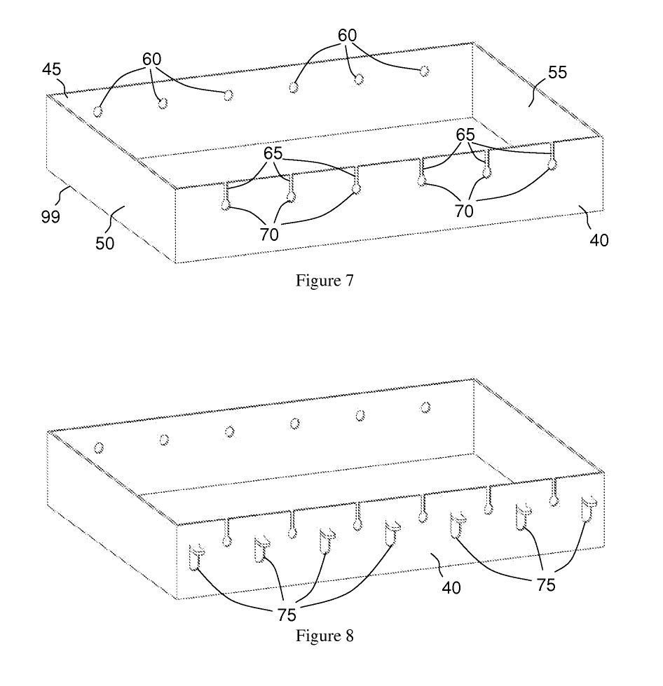

Referring again to FIG. 1 Rear panel 45 is provided with a plurality of equidistantly spaced holes 60, which is large enough to receive the pointed tip 20 and elongated member 15 of skewer 11. On front panel 40, a like plurality of equidistantly spaced lead-in 65 notches extend downwardly from an upper edge but are not visible because the view is blocked by the multiple levers 39 of this embodiment of the skewer 11. In FIG. 7 the lower side of notches 65 terminates in merging edges leading to apertures 70. Apertures 70 receives proximate end 17 of skewer 11. Apertures 70 are slightly larger than width of notches 65. Right side panel 50 and left side panel 55 may include slots (not shown) that serve as grasping areas for transporting rack 99, In another non-limiting embodiment seen in FIG. 8, front panel 40 includes plurality of protrusions 75 equidistantly spaced to support lever 30 of skewer 11. The protrusions 75 are generally positioned on both sides of notches 65. The protrusion 75 can also be positioned adjacent to notches 65 (not visible in FIG. 1 due to multilever indexing means 39) as shown in FIG. 1. The protrusion 75 could be attached to the front panel 40 mechanically for example by welding, threads, or compression fit or the protrusion 75 can also be created as integral part of the front panel 40 as illustrated.

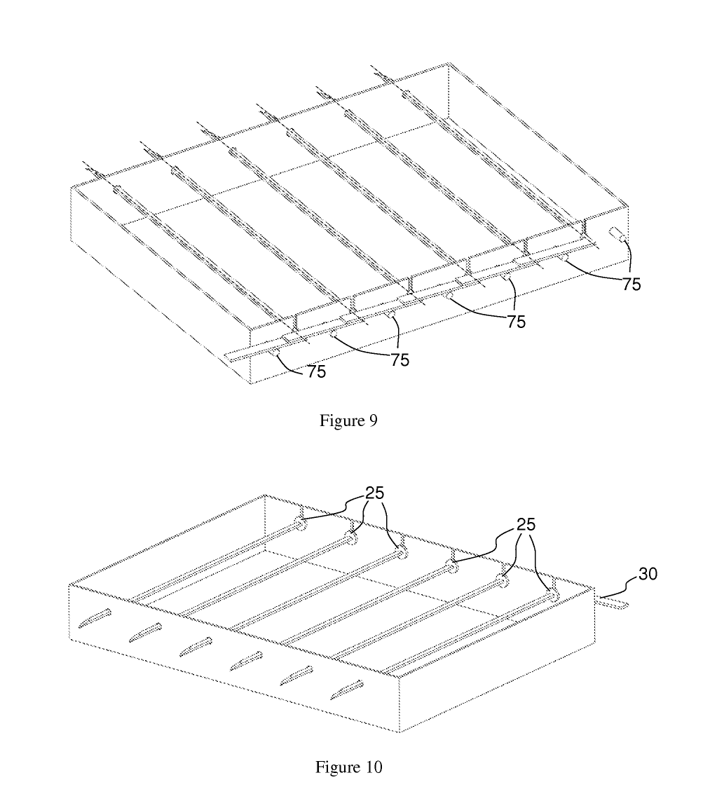

The assembly of the skewers and rack is done as shown in FIGS. 9 and 10 when the optional shoulder 25 is provided in a skewer of the type illustrated in FIG. 3. The shoulder 25 engages a support member such as a panel when a skewer is inserted into the positioning means on front and rear support members. The skewer size is smaller than the slot on the rack and therefore is loosely fit.

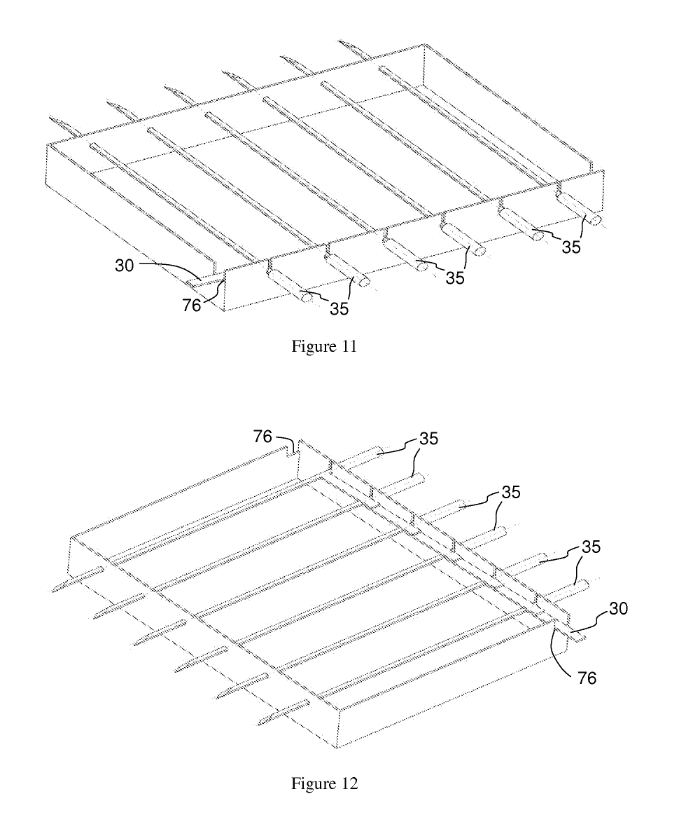

In another arrangement, the right most skewer can have its lever resting on the protrusion on the right side of its elongated member. In this arrangement the left skewer lever is rested on the skewer on right side. The rest of the skewers are arranged in a similar fashion with skewer levers resting on the skewer on the right side. The levers are placed in such a way that they are supported in position by the adjacent skewers as shown in FIGS. 9, 10, 11 and 12. All the levers rest on the skewer to its right or to its left side at a resting position. In the configuration shown in FIGS. 11 and 12 no protrusions are needed as the side panels 50 and 55 provide the needed stopping and support function for the levers. Optionally a notch 76 is placed in panels 50 and 55 to allow a full half turn in each direction when the skewers are rotated. An additional advantage of the assembly shown in FIGS. 11 and 12 is that the positioning of the levers 30 behind the front wall eliminates the need for stop 25 and uses a handle 35 instead securing the skewer from sliding in either direction when fully lowered into the position as illustrated.

In another preferred embodiment, the adjacent stops 75 on either side of the skewer levers are used for resting skewer levers as shown in FIG. 9. Additional stops 75 may be provided to provide additional incremental rotation positions if desired.

A group of food items 90 are impaled onto each of the skewers to load them as shown in FIG. 5. A preferred skewer is flat and wide as shown in FIG. 3. Such skewers reduce the difficulty of turning foods that soften during cooking by reducing spinning of the food on the skewer. The loaded skewers are then inserted inside the openings on the rack as shown in FIG. 5. Once this arrangement is loaded with food and positioned as shown in FIG. 5, the entire rack and skewer assembly is placed by the user in a cooking position. Any cooking method may be used. For example the loaded assembly may be either put on a barbeque grille or inside a convection oven or other cooking arrangement. In the barbeque grille the heat source is at the bottom of the rack. In a convention oven with heat source can be either at the bottom or top or both the sides depending on the user preference. Many other methods known to cooks are useful with the invention. The invention is most useful in situations where the heat source does not surround the food being cooked, which is the circumstance of the most widely used cooking devices. For example in arrangement having a heat source at the bottom of the rack, the food on the skewers is partially cooked from the bottom side first.

The end result of using the novel skewers of the invention is that the food mounted on the skewers is cooked uniformly in at least in two positions. The skewer levers resting on one another makes it easy to rotate and facilitate uniform cooking of all the skewered food items simultaneously. The invention provides improved safety as the user doesn't have to rotate each skewer separately while it is hot. Also, when using an indoor convection oven, it is more hazardous to rotate the skewers while the oven is hot because the user must reach into the oven. But with this innovative system the user can quickly rotate all the skewers by turning only one side skewer and closing back the oven reducing the risk of being burned as well as being more convenient.

This invention can be used on outdoor grills, indoor grills, barbeque pits, convection ovens, surface stoves, and any kind of heat sources made available for cooking food. In another version, the shorter sides of the rack can have slots at the top for supporting longer skewers.

One skilled in the art will be aware that there are thousands of variations of the design features illustrated here in that are mechanical equivalents to the embodiments illustrated herein and preform the equivalent functions the examples above are given by way of illustration and explanation of the inventions and the various means for indexing and moving skewers by engagement of an indexing means either with the adjacent skewer or with the supporting means. The illustrations provided are not intended to limit the invention to the means described in the details above but rather by the claims set out below wherein the phrase means for is intended to claim all variations illustrated herein and the equivalents known to those skilled in the art.

I claim:

1. In a food positioning and supporting skewer for use in a cooking rack system that supports at least one skewer in a plurality of positions, the skewer having an elongated member that includes a proximate end, a distal end, a rotational axis and a tip positioned at the distal end and a support area between the distal end and the proximal end for supporting a plurality of food items; the improvement that comprises an indexing means to fix the position of rotation of the elongated member about the rotational axis.

2. The skewer of claim 1 the indexing means comprises a second elongated member disposed at an angle to the rotational axis of the first elongated member that fixes the rotational position of the skewer in a first position and a second position by contact with a second skewer.

3. The skewer of claim 1 the indexing means comprises a second elongated member disposed at an angle to the rotational axis of the first elongated member that fixes the rotational position of the skewer in a first position and a second position by contact with a portion of the rack system.

4. A first skewer of claim 2 wherein the indexing means of said skewer is of sufficient length to overlap indexing means of an adjacent second skewer of the same design as said first skewer when the two skewers are placed in a rack system having means for supporting at least two skewers in parallel to one another and said rack system support means having a fixed spacing of said first and second skewers and the overlap of said elongated second members interacting to rotate the adjacent second skewer when said first skewer is rotated.

5. The skewer of claim 1 wherein support area for supporting a plurality of food items is shaped to reduce movement of food items relative to the axis of rotation.

6. The skewer of claim 3 wherein the indexing means provides a plurality of indexed stop positions to allow the skewer to be fixed in at least two rotational positions relative to engaging means of the cooking rack system.

7. The skewer of claim 1 that further comprises a stop means that holds the skewer in a fixed relationship to the rack system to prevent the skewer from falling from the rack.

8. A cooking rack system for used in combination with at least two skewers of claim 1 comprising a first support means disposed in relationship to a second support means, the distance separating the first support means from the second support means being less than the distance between the skewer tip and the proximate end of said skewers, and the spacing being sufficient to provide exposure of food placed on the skewer to a heat source adjacent the rack system, and each of said support means having positioning means for holding the at least two skewers in at least one fixed spacial relationship.

9. The rack system of claim 8 wherein the first and second support are spaced apart a distance less than the length of the skewers to be supported, but far enough apart to provide space for food items along more than half the length of the skewers.

10. The rack system of claim 8 wherein the first and second support members each have apertures for receiving the skewers and means to engage an indexing means of the skewer to stop rotational movement of the skewer.

11. The rack system of claim 8 wherein the positioning means for holding the at least two skewers in at least one fixed spacial relationship further comprises a support means having an aperture receivingly engaging the distal end of each skewer and said positioning means also comprising a second support means further comprising a slot that receivingly engages a portion of the skewer with its proximate end engaged with the support means in a spaced apart relationship to said distal end, such that when the skewer is receivingly engaged with the second support means the position of the food supporting portion of the skewer is fixed relative to adjacent skewers.

12. The rack system of claim 11 wherein a stop means is positioned on the skewer near its proximate end and a skewer stop means engages a slotted support means to prevent the skewer from slipping out of engagement with the distal end support means unless the skewer is moved out of engagement with the second support means.

13. The rack system of claim 8 wherein the first and second support members are portions of a closed geometric figure.

14. The rack system of claim 8 wherein the support member receivingly engaging the distal end of the skewer is further provided with means for preventing accidental contact with the tip of the skewer.

15. The rack system of claim 12 wherein a member of the skewer prevents the skewer from being withdrawn from the aperture in the member having an enclosed aperture unless the skewer is moved out of engagement with the second support member.

16. The rack system of claim 13 wherein interaction of a stop or indexing means of the skewer with a first support member prevents motion of the skewer toward the distal end and a second portion of the skewer spaced apart from the portion of the skewer contacting the first support member prevents movement of the skewer away from the distal end.

17. The rack system of claim 8 wherein the indexing means of each skewer is disposed at an angle large enough to permit the indexing means to overlap an adjacent skewer such that rotating the first skewer toward the second skewer will rotate each adjacent skewer to a second position.

18. The rack system of claim 8 wherein a stop means is positioned to engage an indexing means of a skewer to stop rotation of the skewer about the axis of rotation of the skewer.

19. The rack system of claim 8 wherein each skewer has an indexing means that can engage an adjacent skewer when the skewers are placed in engagement with the rack system and the rack system also has a removable stop means to selectively engage an indexing means of a skewer to provide an intermediate stop position when a skewer is rotated such that the degree of rotation of the skewer is less than 180 degrees of rotation from its starting position, and removal of removable stop allows further rotation of the skewer in the same direction of rotation to a second rotational position.
